(19) United States
(12) Patent Application Publication
(10) Pub. No.: US 2024/0348897 A1
(43) Pub. Date: Oct. 17, 2024

(54) VEHICLE CABIN SENSING SYSTEM

(71) Applicant: CONTINENTAL AUTOMOTIVE TECHNOLOGIES GMBH, Hannover (DE)

(72) Inventors: Seng Huat Tan, Singapore (SG); Maximilian Hoepfl, Frankfurt am Main (DE); You Shing Ngim, Singapore (SG); Saptak Sanyal, Singapore (SG)

(73) Assignee: Continental Automotive Technologies GmbH, Hannover (DE)

(21) Appl. No.: 18/682,801

(22) PCT Filed: Jun. 29, 2022
(86) PCT No.: PCT/EP2022/067877

§ 371 Date: Feb. 9, 2024

(30) Foreign Application Priority Data
Aug. 12, 2021 (GB) 2111570.4

(51) Int. Cl. H04N 23/13; G01J 5/00; G06V 10/143; G06V 10/80; G06V 20/59; H04N 23/11

(52) U.S. Cl. CPC H04N 23/13; G01J 5/0025; G06V 10/143; G06V 10/80; G06V 20/59; H04N 23/11; G01J 2005/0077

(57) ABSTRACT

A vehicle cabin sensing system comprises an electronic control unit and a camera system. The camera system comprises multiple image sensors, wherein each image sensor provides respective sensor data, a combination circuit configured to combine the sensor data provided by the image sensors into combined sensor data and an interface configured to transmit the combined sensor data to the electronic control unit. The electronic control unit is configured to receive the combined sensor data and to perform vehicle cabin sensing using the combined sensor data.

### CROSS REFERENCE TO RELATED APPLICATIONS

This US patent application claims the benefit of PCT patent application. No. PCT/EP2022/067877, filed Jun. 29, 2022, which claims the benefit of GB patent application No. 2111570.4, filed Aug. 12, 2021, both of which are hereby incorporated by reference.

### TECHNICAL FIELD

The present disclosure relates to vehicle cabin sensing systems.

### BACKGROUND

Vehicle cabin sensing has multiple applications such as ensuring the safety of passengers and safe driving (e.g. by detecting whether a driver is distracted), implementing human-machine interfaces (e.g. by detection of hand gestures) and avoiding loss of objects (e.g. by detection that a bag has been left in a taxi).

Depending on what is to be sensed, the detection task is not trivial and may require sensor data of different types of sensors to deliver satisfying results (e.g. a colour sensor, a thermal sensor, a time-of-flight (i.e. depth) sensor).

### SUMMARY

An object of the present disclosure is, hence, the efficient provision of sensor data from different types of sensors for vehicle cabin sensing.

According to the present disclosure, this object is attained by vehicle cabin sensing system including an electronic control unit, a camera system including multiple image sensors, wherein each image sensor provides respective sensor data; a combination circuit configured to combine the sensor data provided by the image sensors into combined sensor data and an interface configured to transmit the combined sensor data to the electronic control unit. The electronic control unit is configured to receive the combined sensor data and to perform vehicle cabin sensing using the combined sensor data.

In other words, for example, a vehicle sensing system has a single camera with multiple sensors, capturing the scene in different electromagnetic spectrum bands (e.g. RGB, NIR, LWIR/thermal, etc.) has multiple functions (imaging in RGB, NIR, LWIR/thermal, distance in TOF, audio, etc.). The vehicle cabin sensing system may use sensor and data fusion used to enhance the detection capability by combining the outputs of different sensors. The camera and the electronic control unit may or may not be built into a common housing, i.e. the camera and the electronic control unit may be separate devices (i.e. in separated housings placed at different locations in a vehicle and e.g. connected via a vehicle bus) or they may be included into one device (e.g. a multi-function camera device).

According to various embodiments, in other words, multiple types of images sensors are integrated (combined) into a single camera system (or camera device), their output is transmitted in combined form to an electronic control unit (i.e. via a single connection or link, e.g. via a single cable) which uses the sensor data with which it is provided for cabin sensing.

According to one embodiment, the image sensors capture image data in different electromagnetic spectra.

According to one embodiment, the image sensors include at least two of a near-infrared image sensor, a longwave infrared or thermal image sensor, a depth image sensor and a colour image sensor.

According to one embodiment, the image sensors include all of a near-infrared image sensor, a longwave infrared or thermal image sensor, a depth image sensor and a colour image sensor.

According to one embodiment, the interface is configured to transmit the combined sensor data stream to the electronic control unit via serial data communication.

According to one embodiment, the interface includes a Serializer/Deserializer and is configured to transmit the combined sensor data stream to the electronic control unit using the Serializer/Deserializer.

According to one embodiment, performing vehicle cabin sensing includes performing detection of at least one of the detection of the presence of persons or objects or both in the vehicle cabin and the detection of activities in the vehicle cabin.

According to one embodiment, the electronic control unit includes a processor configured to separate the combined sensor data into the respective sensor data provided by the respective image sensors and to perform the vehicle cabin sensing using the sensor data provided by the image sensors.

According to one embodiment, the processor is configured to perform the vehicle cabin sensing using data fusion of the sensor data.

According to one embodiment, the camera system includes a housing in which the multiple image sensors are arranged.

According to one embodiment, the camera system includes one or more optical systems for the image sensors, wherein the one or more optical systems are arranged in the housing.

According to one embodiment, the camera system includes a respective optical system for each image sensor, wherein, for each image sensor, the respective optical system is arranged in the housing.

According to one embodiment, the image sensors have different resolutions.

According to one embodiment, the multiple image sensors include a thermal image sensor and a colour image sensor, wherein the resolution of the colour image sensor is higher than the resolution of the thermal image sensor.

According to one embodiment, the resolution of the colour image sensor is at least double or at least four times higher than the resolution of the thermal image sensor.

Further, a vehicle including a vehicle sensing system according to one of the embodiments described above may be provided.

### BRIEF DESCRIPTION OF DRAWINGS

The present disclosure will be described in more detail in the following with reference to the accompanying drawings:

FIG. 1 shows a vehicle; and

FIG. 2 shows a vehicle cabin sensing system.

### DETAILED DESCRIPTION

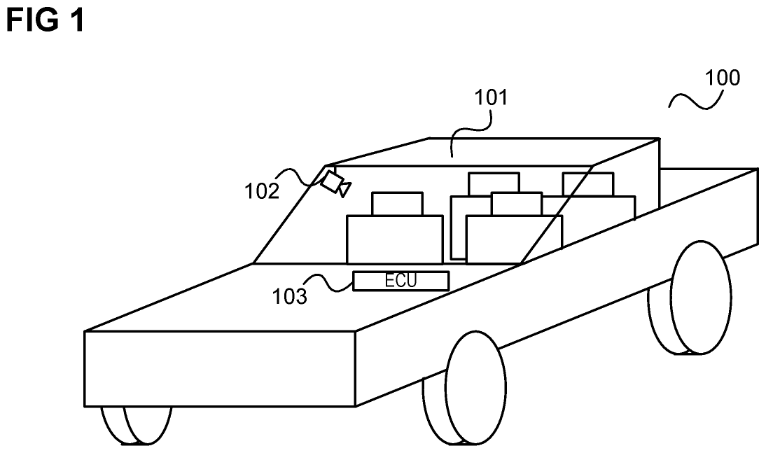

FIG. 1 shows a vehicle 100.

The vehicle has a vehicle cabin 101 with seats for passengers.

For various reasons, many different events may need to be detected inside the vehicle cabin 101. These events for example include, among many others, presence of occupants (baby, child, adult, pets), e.g. to ensure that children are not left in the vehicle cabin 101, presence of objects (child seats, boxes, bags, books, phones, cigarettes, etc), e.g. to ensure that nothing is left in a taxi or that a child seat is used, activities such as driving, drinking, smoking, phoning, audio and video conferencing or use of social media, e.g. for safety reasons, hand gesturing as for input to a human-machine interface (HMI), rising temperature, breathing, heartbeat, e.g. to ensure the comfort & health of the occupants.

Such kinds of events may be detected (with differing effectiveness) by using one or more image sensors 102 providing various sensing functions such as taking colour (e.g. RGB) images, near-infrared (NIR) images, longwave infrared (LWIR) or thermal images, or depth (e.g. TOF (time-of-flight)) images.

The vehicle 100 may for example have an electronic control unit 103 which is configured to receive sensor (image) data from the one or more sensor devices 102, process the sensor data and take corresponding images, e.g. display a warning to the driver if it detects, based on sensor data, that the driver uses a telephone.

A sensor device 102 providing one single sensing function may have some limitations in the sensing effectiveness, i.e. may not be sufficient to accurately detect one of the above events, i.e. fulfil the sensing requirement. To overcome this limitation, two or more sensors with different sensing functions may be used to meet the sensing requirement. However, having multiple sensors (e.g. camera sensors) housed in separate camera devices result in a multi-camera system which takes up significant installation space in the limited vehicle cabin space, limits the flexibility to locate cameras, increase the sensing system cost significantly (multiple cameras & cables), leads to high power consumption.

According to various embodiment, multiple sensors and sensing functions (e.g. for taking RGB, NIR, TOF, LWIR/thermal images) are integrated into one single camera system (or device, in a single camera housing, i.e. the camera system may be in the form of a single camera device), resulting in a compact one-camera system with improved (event) detection performance using sensor and data fusion.

Integrating multiple sensing functions into one single (small) camera system allows improving sensing performance and capability by combining sensing functions, sensor and data fusion; this allows covering a larger class of events to be detected reducing overall system size and installation space, deployment in very small spaces which does not all placing multiple cameras, improved flexibility to place the camera system for maximum effectiveness, reduced overall complexity which improves reliability and performance and reduces overall system cost, reduced overall power consumption.

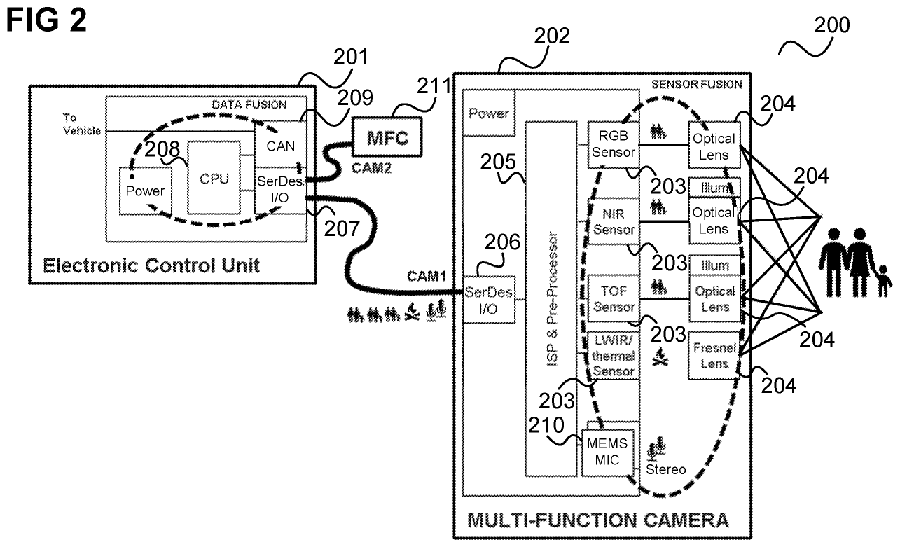

FIG. 2 shows a vehicle cabin sensing system 200 according to an embodiment.

The vehicle cabin sensing system 200 includes an electronic control unit 201, for example corresponding to ECU 103, and a multi-function camera (system) 202, for example corresponding to sensor device 102.

The multi-function camera 202 includes multiple image sensors 203 for different sensing functions, i.e. the multi-function camera 202 includes multiple image sensors of different sensor types (e.g. RGB, NIR, TOF, LWIR/thermal sensor) built into a single camera. Each image sensor 203 has its respective optical system 204 to view the interior of the vehicle cabin 101.

Sensor fusion (where a sensor combines two or more sensing functions) may be used to reduce the number of image sensors 203.

A processor (e.g. an ISP (image signal processor) & Pre-Processor) 205 prepares and merges the sensor data streams provided by the sensors 203 into a single data stream (i.e. into combined sensor data) and transmits it to the ECU 201 by a SerDes (Serializer/Deserializer) interface 206 via a SerDes serial link. The transmitted serial data is received at the ECU 201 (by a counterpart SerDes 207). The ECU 201 (e.g. by a CPU 208) separates the multiple sensor data streams and extracts them to be processed by algorithms for the respective application (e.g. object detection). Depending on the result of the processing, the ECU 201 may output control signals to other components of the vehicle 100 (e.g. control a display to display a warning), e.g. via a CAN (Controller Area Network) bus interface 209.

The multi-function camera 201 may also include one or more other sensors than image sensors, in this example a MEMS (Micro-Electro-Mechanical-System) microphone 210. The sensor data provided by theses one or more other sensors may also be combined into the single data stream and used by the ECU 201 in the detection processing.

The ECU 201 may be connected to a plurality of multi-function cameras like the multi-function camera 202, in this example a second multi-function camera 211. The ECU 201 may combine the sensor data received from multiple multi-function cameras 211 or may combine the results of the processing of the sensor data received from multiple multi-function cameras.

Nevertheless, the number of connection lines (cables) of the ECU 201 is significantly reduced in comparison to a configuration wherein the image sensor 203 are implemented (placed and connected) separately (and e.g. in separate housings). For a single multi-function camera 202, for example, there is only one cable needed between the ECU 201 to the multi-function camera 202 while four (or even five when counting the microphone 210) cables would be necessary if the sensors were placed and connected separately.

Data fusion, where the data from different sensors are combined to extract additional information and improve the sensor raw information, may be implemented on the ECU 201 to improve the camera detection performance and functionality.

For example, a thermal image sensor with low resolution and a colour image sensor (e.g. RGB camera) may be integrated in the camera system 202 for the reason is that a thermal image sensor with high resolution would be too costly. By combining the sensor data of both sensors (i.e. by performing vehicle cabin sensing using data fusion), the ECU 201 can perform high-quality detection because it can benefit from the expressive thermal sensor data (e.g. for detecting persons) while benefiting from the high resolution of the colour image sensor.

1. A vehicle cabin sensing system comprising:
an electronic control unit;
a camera system comprising:
multiple image sensors, wherein each image sensor provides respective sensor data;
a combination circuit configured to combine the sensor data provided by the image sensors into combined sensor data; and
an interface configured to transmit the combined sensor data to the electronic control unit;
wherein the electronic control unit is configured to receive the combined sensor data and to perform vehicle cabin sensing using the combined sensor data.

2. The vehicle cabin sensing system of claim 1, wherein the image sensors are operable to capture image data in different electromagnetic spectra.

3. The vehicle cabin sensing system of claim 1, wherein the image sensors include at least two of a near-infrared image sensor, a longwave infrared or thermal image sensor, a depth image sensor and a colour image sensor.

4. The vehicle cabin sensing system of claim 1, wherein the image sensors include all of a near-infrared image sensor, a longwave infrared or thermal image sensor, a depth image sensor and a colour image sensor.

5. The vehicle cabin sensing system of claim 1, wherein the interface is configured to transmit the combined sensor data stream to the electronic control unit via serial data communication.

6. The vehicle cabin sensing system of claim 1, wherein the interface comprises a Serializer/Deserializer and is configured to transmit the combined sensor data stream to the electronic control unit using the Serializer/Deserializer.

7. The vehicle cabin sensing system of claim 1, wherein performing vehicle cabin sensing comprises performing detection of at least one of
the detection of the presence of persons or objects or both in the vehicle cabin, and
the detection of activities in the vehicle cabin.

8. The vehicle cabin sensing system of claim 1, wherein the electronic control unit further comprises a processor configured to separate the combined sensor data into the respective sensor data provided by the respective image sensors and to perform the vehicle cabin sensing using the sensor data provided by the image sensors.

9. The vehicle cabin sensing system of claim 8, wherein the processor is configured to perform the vehicle cabin sensing using data fusion of the sensor data.

10. The vehicle cabin sensing system of claim 1, wherein the camera system comprises a housing in which the multiple image sensors are arranged.

11. The vehicle cabin sensing system of claim 1, wherein the camera system comprises one or more optical systems for the image sensors, wherein the one or more optical systems are arranged in the housing.

12. The vehicle cabin sensing system of claim 1, wherein the camera system comprises a respective optical system for each image sensor, wherein, for each image sensor, the respective optical system is arranged in the housing.

13. The vehicle cabin sensing system of claim 1, wherein the image sensors have different resolutions.

14. The vehicle cabin sensing system of claim 1, wherein the multiple image sensors comprise a thermal image sensor and a colour image sensor, wherein the resolution of the colour image sensor is higher than the resolution of the thermal image sensor.

15. The vehicle cabin sensing system of claim 1, wherein the resolution of the colour image sensor is at least double or at least four times higher than the resolution of the thermal image sensor.
